(19) United States
(12) Patent Application Publication
(10) Pub. No.: US 2025/0007614 A1
(43) Pub. Date: Jan. 2, 2025

(54) APPARATUS AND METHOD FOR ALLOCATING WAVELENGTHS FOR OPTICAL SIGNALS IN OPTICAL ACCESS NETWORK

(71) Applicant: Electronics and Telecommunications Research Institute, Daejeon (KR)

(72) Inventors: Han Hyub LEE, Daejeon (KR); Hwan Seok CHUNG, Daejeon (KR)

(73) Assignee: Electronics and Telecommunications Research Institute, Daejeon (KR)

(21) Appl. No.: 18/757,716

(22) Filed: Jun. 28, 2024

(30) Foreign Application Priority Data
Jun. 30, 2023 (KR) 10-2023-0085033
Apr. 15, 2024 (KR) 10-2024-0050164

(51) Int. Cl. H04B 10/40; H04B 10/25

(52) U.S. Cl. CPC H04B 10/40; H04B 10/2589

(57) ABSTRACT

Proposed is an operation method of an optical transceiver. The operation method includes determining a first center wavelength for a downstream optical signal, determining a second center wavelength for an upstream optical signal, allocating the first center wavelength to a downstream optical signal, allocating the second center wavelength to an upstream optical signal, wherein the first center wavelength and the second center wavelength has a separation distance corresponding to a predetermined wavelength spacing therebetween, and separating the downstream optical signal and the upstream optical signal on the basis of the separation distance.

### CROSS REFERENCE TO RELATED APPLICATION

The present application claims priority to Korean Patent Application No. 10-2023-0085033, filed 30 Jun. 2023, and 10-2024-0050164 filed Apr. 15, 2024, the entire contents of which is incorporated herein for all purposes by this reference.

### BACKGROUND OF THE INVENTION

### Field of the Invention

The present disclosure relates to a method and apparatus for allocating wavelengths in a bidirectional optical access network. More particularly, the present disclosure relates to a technology for allocating operating wavelengths of a bidirectional optical transceiver used in the physical layer of a bidirectional optical access network.

### Description of the Related Art

In an Ethernet-based bidirectional optical access network, an optical transceiver is required to perform both downstream transmission and upstream transmission. A bidirectional optical access network refers to a method of transmitting optical signals in different directions using a single optical fiber. In this case, it is required to set a center wavelength for downstream transmission and a center wavelength for upstream transmission separately.

Herein, the optical transceiver may include both a laser diode for transmitting optical signals and a photodiode for receiving optical signals. Loss may occur in a process of filtering optical signals transmitted or received through downstream transmission and upstream transmission. In addition, a penalty may exist due to chromatic dispersion in an optical fiber when optical signals are transmitted through the optical fiber.

Therefore, it is necessary to allocate center wavelengths for transmitting and receiving optical signals considering the chromatic dispersion penalty in the optical fiber and the loss in downstream transmission and upstream transmission by the optical transceiver. In addition, it is possible to increase the transmission rate of an optical link by using a wavelength division multiplexing method for optical signals of different wavelengths, so it is necessary to allocate the center wavelength and the wavelength range for each optical signal.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a method and an apparatus for increasing the operational accuracy of an optical transceiver considering a penalty occurring in an optical fiber and loss existing in the optical transceiver, to allocate center wavelengths for upstream transmission and downstream transmission by the optical transceiver.

According to an embodiment of the present disclosure, there is provided an operation method of an optical transceiver, the operation method including: determining a first center wavelength for a downstream optical signal; determining a second center wavelength for an upstream optical signal; allocating the first center wavelength to a downstream optical signal; allocating the second center wavelength to an upstream optical signal, the first center wavelength and the second center wavelength having a separation distance corresponding to a predetermined wavelength spacing therebetween; and separating the downstream optical signal and the upstream optical signal on the basis of the separation distance.

In addition, the first center wavelength may be allocated greater than the second center wavelength.

In addition, the upstream optical signal and the downstream optical signal may be transmitted through a single-mode optical fiber.

In addition, the optical transceiver may be configured to operate with an operating range of up to 40 km.

In addition, the determining of the first center wavelength for the downstream optical signal or the determining of the second center wavelength for the upstream optical signal may include: identifying a signal transmission penalty caused by chromatic dispersion in an optical fiber, and determining the first center wavelength or the second center wavelength on the basis of the transfer penalty.

In addition, the determining of the first center wavelength for the downstream optical signal or the determining of the second center wavelength for the upstream optical signal may include determining the first center wavelength or the second center wavelength on the basis of a modulation method of the downstream optical signal or the upstream optical signal.

According to an embodiment of the present disclosure, there is provided an apparatus for an optical transceiver, the apparatus including: the transceiver; and at least one controller operably connected to the transceiver, wherein the at least one controller is configured to perform: determining a first center wavelength for a downstream optical signal; determining a second center wavelength for an upstream optical signal; allocating the first center wavelength to a downstream optical signal; allocating the second center wavelength to an upstream optical signal, the first center wavelength and the second center wavelength having a separation distance corresponding to a predetermined wavelength spacing therebetween; and separating the downstream and upstream optical signal from the upstream optical signal on the basis of the separation distance.

In addition, the first center wavelength may be allocated greater than the second center wavelength.

In addition, the upstream optical signal and the downstream optical signal may be transmitted through a single-mode optical fiber.

In addition, the optical transceiver may be configured to operate with an operating range of up to 40 km.

In addition, the at least one controller may be configured to further perform, in the determining of the first center wavelength for the downstream optical signal or the determining of the second center wavelength for the upstream optical signal, identifying a signal transmission penalty caused by chromatic dispersion in an optical fiber; and determining the first center wavelength or the second center wavelength on the basis of the transfer penalty.

In addition, the at least one controller may be configured to further perform, in the determining of the first center wavelength for the downstream optical signal or the determining of the second center wavelength for the upstream optical signal, determining the first center wavelength or the second center wavelength on the basis of a modulation method of the downstream optical signal or the upstream optical signal.

The optical transceiver according to an embodiment of the present disclosure can increase the accuracy of the optical transceiver considering the penalty occurring in the optical fiber and the loss existing in the optical transceiver, to allocate the center wavelengths for upstream transmission and downstream transmission.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating the operation of an optical transceiver according to an embodiment of the present disclosure;

FIG. 2 is a diagram illustrating an internal structure of an optical transceiver according to an embodiment of the present disclosure;

FIG. 3 is a diagram illustrating separation of a center wavelength for upstream transmission from a center wavelength for downstream transmission according to an embodiment of the present disclosure;

FIG. 4 is a diagram illustrating a ratio between an optical signal and a noise signal caused by FWM, which may occur in an optical fiber, depending on a wavelength spacing according to an embodiment of the present disclosure;

FIG. 5 is a diagram illustrating examples of an optical transceiver's center wavelengths for downstream transmission and upstream transmission according to an embodiment of the present disclosure; and

FIG. 6 is a flowchart illustrating the operation of an optical transceiver according to an embodiment of the present disclosure.

### DETAILED DESCRIPTION OF THE INVENTION

Hereinafter, embodiments will be described in detail with reference to the accompanying drawings. However, the scope of the present disclosure is not limited to the embodiments. The same reference numerals used throughout the drawings refer to the same elements.

Various changes may be made to the embodiments described below. It should be understood that the embodiments described below are not intended to limit the present disclosure and the present disclosure includes all changes, equivalents, and substitutes of the embodiments.

Term “first” or “second” can be used to describe various elements, but the terms are only used to differentiate one element from the other elements. For example, the “first” element may be named the “second” element, and the “second” element may also be similarly named the “first” element.

The terms used in the embodiments are merely used to describe particular embodiments, and are not intended to limit the embodiments. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Unless otherwise defined in the specification, all terms including technical and scientific terms used herein have the same meaning as commonly understood by those skilled in the art to which the embodiments belong. It will be further understood that terms used herein should be interpreted as having a meaning that is consistent with their meaning in the context of this specification and the relevant art and will not be interpreted in an idealized or overly formal sense unless expressly so defined herein.

In addition, in describing the present disclosure with reference to the accompanying drawings, the same elements are assigned the same reference numerals regardless of the signs on the drawings, and a redundant description thereof will be omitted. In describing the present disclosure, if it is decided that a detailed description of the known art related to the present disclosure makes the subject matter of the present disclosure unclear, the detailed description will be omitted.

Hereinafter, the embodiments of the present disclosure will be described in detail with reference to the accompanying drawings.

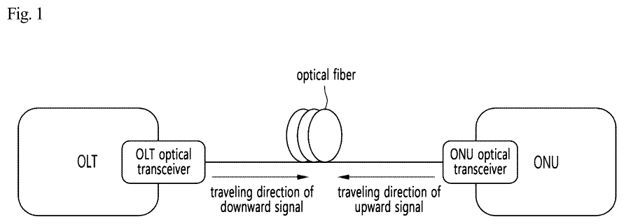

FIG. 1 is a diagram illustrating the operation of an optical transceiver according to an embodiment of the present disclosure.

FIG. 1 shows two optical transceivers connected to each other via an optical fiber for bidirectional optical access.

Herein, an optical line terminal (OLT) optical transceiver may be used for an OLT and an optical network unit (ONU) optical transceiver may be used for an ONU. In addition, the optical fiber may be a single-mode optical fiber.

The optical transceivers may be capable of bidirectional transmission. For example, each optical transceiver may operate with the transfer rate (data rate) of 50 Gb/s per wavelength, and may transmit data at the transfer rate of up to 100 Gb/s using two optical signals.

In addition, the operating range of each optical transceiver may be classified as 10 km, 20 km, 40 km, or more than 40 km.

According to this classification, when an optical transceiver has the transfer rate (data rate) of 100 Gb/s and the rate of 50 Gb/s per wavelength, the optical transceiver may be classified as 100GBASE-BR2-40 or 100GBASE-BR40-2 at the physical layer (PHY) depending on its operating range.

The optical transceivers may be classified as being downstream and upstream depending on the identifiers D and U, respectively. The identifier D may be for the OLT PHY, and the identifier U may be for the ONU PHY.

For example, 100GBASE-BR40-2-D may refer to an OLT at a bidirectional optical access physical layer that supports a transmission distance of up to 40 km, which is the operating range, using two wavelengths with the transfer rate of 50 Gb/s per wavelength through a single-mode optical fiber for downstream transmission.

In addition, 100GBASE-BR40-2-U may refer to an ONU at a bidirectional optical access physical layer that supports a transmission distance of up to 40 km, which is the operating range, using two wavelengths with the transfer rate of 50 Gb/s per wavelength through a single-mode optical fiber for upstream transmission.

For downstream transmission, the OLT optical transceiver may perform a transmission function, and the ONU optical transceiver may perform a reception function. Similarly, for upstream transmission, the OLT optical transceiver may perform a reception function, and the ONU optical transceiver may perform a transmission function.

The present disclosure relates to a wavelength allocation technology for an optical transceiver. The OLT may set a center wavelength for downstream transmission to the ONU. The center wavelength for downstream transmission may be allocated to an optical signal that the OLT optical transceiver outputs to the ONU optical transceiver.

In addition, the ONU may set a center wavelength for upstream transmission to the OLT. The center wavelength for upstream transmission may be allocated to an optical signal that the ONU optical transceiver outputs to the OLT optical transceiver.

Herein, center wavelength allocation for an optical transceiver may be determined considering a signal transmission penalty caused by chromatic dispersion, which occurs when an optical signal is transmitted through the optical fiber, and considering a penalty caused by a non-linear phenomenon, such as four-wave mixing (FWM), which may occur when chromatic dispersion is low, conversely.

Hereinafter, center wavelength allocation for an optical transceiver will be described in more detail.

The present disclosure will be described focusing on an optical transceiver that supports the transfer rate of 100 Gb/s using two optical signals with the transfer rate of 50 Gb/s per wavelength, but is not limited thereto.

The present disclosure provides a center wavelength plan for downstream transmission and upstream transmission considering the characteristics of a light source used in an optical transceiver and an optical fiber. According to an embodiment of the present disclosure, the light source may mean a type of a laser diode, and may include an uncooled DFB LD or a cooled EML. In addition, an optical filter used in the optical transceiver may be a total reflection filter or a bandpass filter.

According to an embodiment of the present disclosure, a center wavelength for downstream transmission or upstream transmission may be determined considering the signal transmission penalty caused by the chromatic dispersion in the optical fiber. For example, in order to transmit a 50 Gb/s optical signal 40 km using pulse amplitude modulation 4-level (PAM-4), the 1300-nm wavelength band with low chromatic dispersion in the optical fiber needs to be used.

The above description will be described in terms of an optical line terminal as which the OLT optical transceiver is applied and an optical network unit as which the ONU optical transceiver is applied.

The optical line terminal may set a downstream center wavelength for downstream transmission to the optical network unit. In addition, the optical line terminal may allocate the center wavelength to a downstream optical signal for downstream transmission. Similarly, the optical network unit may set an upstream center wavelength different from the center wavelength allocated to an optical signal for downstream transmission by the optical line terminal. The optical network unit may allocate the center wavelength to an upstream optical signal for upstream transmission to the optical line terminal.

Herein, the downstream signal center wavelength may be separated by a preset interval from the upstream center wavelength allocated to the upstream optical signal transmitted from the optical network unit through upstream transmission. The optical line terminal may provide downstream transmission of the downstream optical signal to which the center wavelength is allocated to the optical network unit through the single-mode optical fiber. Herein, the downstream center wavelength may be allocated greater than the upstream center wavelength.

The optical line terminal may provide the downstream optical signal to the optical network unit through downstream transmission at the transfer rate of 2×50 Gb/s. In addition, the optical line terminal may operate with the operating range of up to 40 km, and the downstream center wavelength range may be determined on the basis of the operating range.

In addition, the optical network unit may provide the upstream optical signal to the optical line terminal through upstream transmission at the transfer rate of 2×50 Gb/s. In addition, the optical network unit may operate with the operating range of up to 40 km, and the upstream center wavelength range may be determined on the basis of the operating range.

For example, when the optical line terminal operates with the transfer rate of 2×50 Gb/s and the operating range of up to 40 km, the center wavelength for downstream transmission may be set within a wavelength range greater than 1300.05 nm.

In addition, when the optical network unit operates with the transfer rate of 2×50 Gb/s and the operating range of up to 40 km, the upstream center wavelength for upstream transmission may be set within a wavelength range less than 1304.58 nm.

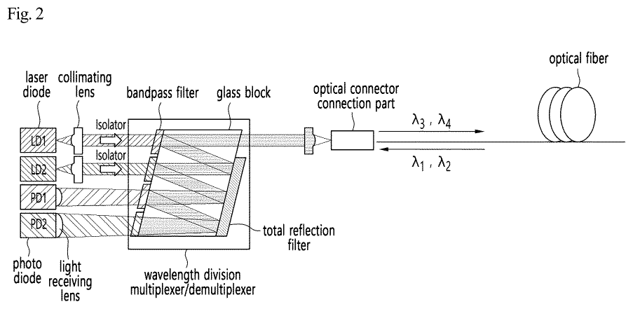

FIG. 2 is a diagram illustrating the internal structure of an optical transceiver according to an embodiment of the present disclosure.

Specifically, FIG. 2 illustratively shows an optical signal transmission and reception part of the internal structure of an optical transceiver for Ethernet transmission. As described above, the optical transceivers may correspond to the optical line terminal and the optical network unit.

The OLT optical transceiver may include: laser diodes (LDs); collimating lenses; isolators for transmitting light in only one direction; a wavelength multiplexer/demultiplexer having a function of performing wavelength multiplexing on optical signals output from the LDs and performing wavelength demultiplexing on the input optical signals; and photodiodes for receiving the optical signals. The wavelength multiplexer/demultiplexer includes: bandpass filters for transmitting or reflecting light depending on wavelength; a total reflection filter for reflecting all light rays regardless of wavelength; and a glass block to which the filters are attached. Similarly to the OLT optical transceiver, the ONU optical transceiver may include laser diodes, photodiodes, lenses, and a wavelength multiplexer/demultiplexer.

The OLT optical transceiver and the ONU optical transceiver may have a structure that include optical transmitter corresponding to the laser diodes for transmission of optical signals and optical receiver corresponding to the photodiodes for reception of optical signals, and uses bidirectional optical sub-assembly (BOSA) provided as a single input/output port.

According to an embodiment of the present disclosure, the laser diodes, which are light sources, may be electro-absorption modulated lasers (EMLs) or directly modulated lasers (DMLs). In addition, the photodiodes may be PiN photodiodes (PiN-PDs) or avalanche photodiodes (APDs).

As shown in FIG. 2, when the OLT optical transceiver and the ONU optical transceiver transmit and receive optical signals through the single-mode optical fiber, the signal transmission penalty caused by the chromatic dispersion in the optical fiber, the penalty caused by the non-linear phenomenon, and the loss when beams are reflected from the wavelength division multiplexer/demultiplexer may occur. Accordingly, considering the penalties and loss, the center wavelengths for the OLT optical transceiver and the ONU optical transceiver may be set.

In FIG. 2, wavelengths λ₁ and λ₂ may mean the center wavelengths for downstream transmission from the OLT optical transceiver to the ONU optical transceiver. In addition, wavelengths λ₃ and λ₄ may mean the center wavelengths for upstream transmission from the ONU optical transceiver to the OLT optical transceiver.

As described above, according to the present disclosure, an optical transceiver using BOSA and a wavelength multiplexer/demultiplexer used in the optical transceiver for downstream transmission or upstream transmission can be manufactured at low cost.

Herein, a center wavelength for downstream transmission and a center wavelength for upstream transmission are allocated spaced apart from each other by a preset wavelength spacing, so that the filters applied in the wavelength division multiplexer/demultiplexer can easily separate an optical signal for downstream transmission from an optical signal for upstream transmission. In addition, a center wavelength for downstream transmission may be set to be greater than a center wavelength for upstream transmission.

Herein, the wider the preset wavelength spacing between a center wavelength for upstream transmission and a center wavelength for downstream transmission, the lower the fabrication cost of the bandpass filters applied in the wavelength division multiplexer/demultiplexer. Therefore, the cost of the optical transceiver having the BOSA structure may be reduced. However, the preset wavelength spacing between a center wavelength for upstream transmission and a center wavelength for downstream transmission needs to be determined considering the signal transmission penalty of optical signals caused by chromatic dispersion occurring in the optical fiber. In addition, the wavelength spacing may be determined considering the chromatic dispersion value of the optical fiber.

Hereinafter, separation of a center wavelength for downstream transmission from a center wavelength for upstream transmission through the filters applied in the wavelength division multiplexer/demultiplexer will be described.

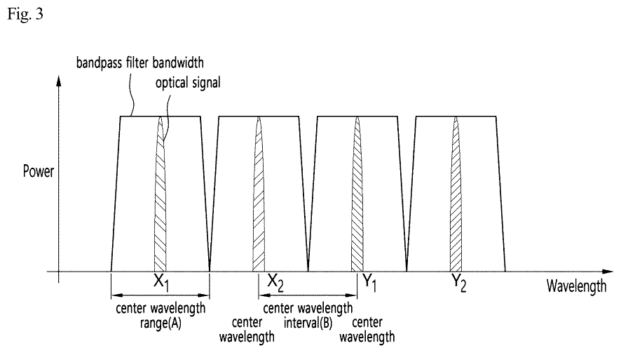

FIG. 3 shows a center wavelength range applied to an optical signal for upstream transmission and a center wavelength range applied to an optical signal for downstream transmission.

Referring to FIG. 3, the center wavelengths X₁ and X₂ applied to optical signals for upstream transmission and the center wavelengths Y₁ and Y₂ applied to optical signals for downstream transmission may be separated by the bandpass filters applied in the wavelength division multiplexer/demultiplexer, respectively.

Herein, as the filters applied in the wavelength division multiplexer/demultiplexer, the bandpass filters and the total reflection filter may be used. Each bandpass filter may pass only an optical signal of the wavelength corresponding to the transmission bandwidth among incident optical signals and may reflect the optical signals of the wavelengths other than the transmission bandwidth. The total reflection filter may reflect optical signals in all bands.

To this end, as shown in FIG. 3, a center wavelength applied to an optical signal for upstream transmission and a center wavelength applied to an optical signal for downstream transmission may be allocated spaced apart from each other by a preset wavelength spacing. Accordingly, the filters described with reference to FIG. 3 may operate in such a manner that wavelength division multiplexing or demultiplexing is performed on a center wavelength for upstream transmission and a center wavelength for downstream transmission.

In the present disclosure, an optical transceiver that performs both downstream transmission and upstream transmission may have the BOSA structure including LDs and PDs. When downstream transmission and upstream transmission are performed, the transfer dispersion penalty may occur in the optical fiber.

Herein, the transfer dispersion penalty is proportional to the dispersion value of the optical fiber. Therefore, the greater the wavelength of an optical signal, the grater the penalty. The increase in the signal transmission penalty may be compensated for by the increase in the optical signals input to the PDs. In addition, while the optical signals output from the LDs or the optical signals input to the PDs according to upstream transmission or downstream transmission travel the optical transfer paths in the wavelength division multiplexer/demultiplexer, insertion loss may occur.

Herein, the insertion loss may increase depending on the number of times that the wavelength division multiplexer/demultiplexer reflects light. Therefore, a signal of a wavelength with a large signal transmission penalty reduces the number of times that the wavelength division multiplexer/demultiplexer reflects light, thereby minimizing the loss.

Thus, according to an embodiment of the present disclosure, the wavelength ranges in which a center wavelength for downstream transmission and a center wavelength for upstream transmission are allocated may be determined on the basis of the minimum loss or the penalty from a combined result of the transfer dispersion penalty and the insertion loss.

The center wavelengths (or center frequencies) and the wavelength ranges of the upstream channels and the downstream channels may be determined considering the characteristics of the optical fiber connecting the OLT and the ONU. In particular, when optical signals travel the optical fiber, a phenomenon (so-called chromatic dispersion) in which the traveling speeds of the optical signals are determined according to the wavelengths of the optical signals may occur. In particular, when the traveling speeds of optical signals are the same due to chromatic dispersion (that is, chromatic dispersion is 0 ps/nm/km), the optical signals travel at the same speed in the optical fiber and non-linear distortion may thus occur. This non-linear distortion may be referred to as four-wave mixing (FWM). The upstream channels and the downstream channels may be determined considering the degree of chromatic dispersion occurring in the optical fiber, the occurrence of FWM, or the degree of FWM.

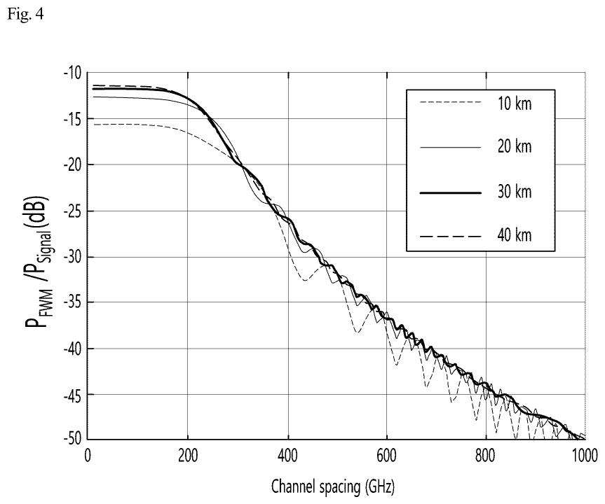

FIG. 4 shows a calculated ratio between an optical signal and an FWM noise signal caused by FWM, which may occur in an optical fiber. Calculation was made with the length of the optical fiber varying from 10 km to 40 km. According to a result of calculation, it can be seen that when the wavelength spacing between at least two signals is equal to or greater than 800 GHz, the ratio between the FWM noise signal and the optical signal is equal to or less than 45 dB. Therefore, to minimize the dispersion penalty of an optical signal, a center wavelength range needs to be set in a band where a dispersion value of an optical fiber is 0 (zero), and the interval between the center wavelengths of signals needs to be at least 800 GHz. The wavelength band in which the chromatic dispersion in the optical fiber is 0 ps/nm-km ranges from 1300 nm to 1324 nm.

Different wavelength ranges in which center wavelengths are allocated may be determined for downstream transmission and upstream transmission. In addition, a center wavelength range for downstream transmission and a center wavelength range for upstream transmission may be determined spaced apart from each other by a preset wavelength spacing. Herein, the wavelength spacing between the center wavelength range for downstream transmission and the center wavelength range for upstream transmission may mean a center wavelength spacing of a filter used in the wavelength division multiplexer/demultiplexer.

Herein, a preset center wavelength spacing may be a wavelength spacing for avoiding the penalty due to the occurrence of FWM in the optical fiber.

In addition, for the same optical transceiver, a wavelength spacing (bandwidth) corresponding to the center wavelength range for downstream transmission and a wavelength spacing corresponding to the center wavelength range for upstream transmission may be determined to be the same. However, for optical transceivers with different operating ranges, wavelength spacings (bandwidths) corresponding to center wavelength ranges for downstream transmission may be determined to be the same or different from each other. Similarly, for optical transceivers with different operating ranges, wavelength spacings (bandwidths) corresponding to center wavelength ranges for upstream transmission may be determined to be the same or different from each other.

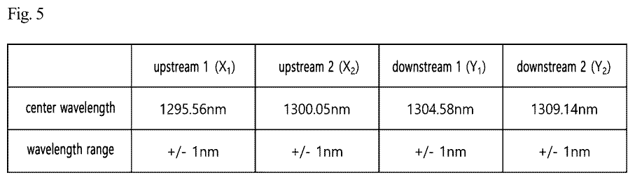

FIG. 5 is a diagram illustrating examples of center wavelengths for upstream transmission and downstream transmission allocated to a 100GBASE optical transceiver with the operating range of 40 km according to an embodiment of the present disclosure.

FIG. 5 shows center wavelengths for downstream transmission and center wavelengths for upstream transmission according to the operating range in the optical transceiver operating with the transfer rate of 50 Gb/s. A center wavelength for downstream transmission may be set by an optical line terminal, which is an optical transceiver, and a center wavelength for upstream transmission may be set by an optical network unit, which is an optical transceiver. Since downstream transmission and upstream transmission are performed through the optical fiber between the optical line terminal and the optical network unit, the optical line terminal and the optical network unit may perform bidirectional optical access.

When the optical line terminal operates with the transfer rate of 50 Gb/s and the operating range of 40 km, two center wavelengths for downstream transmission may be set within the wavelength range from 1303.54 nm to 1310.19 nm. In addition, when the optical network unit operates with the transfer rate of 50 Gb/s and the operating range of 40 km, two center wavelengths for upstream transmission may be set within the wavelength range from 1294.53 nm to 1301.09 nm.

Herein, in the optical line terminal and the optical network unit operating with the transfer rate of 50 Gb/s and the operating range of 40 km, a laser for generating optical signals may be an external modulation laser, photodiodes for receiving optical signals may be APDs, and a BOSA structure realized with collimated beam optics may be used. For operation with the operating range of 40 km, it is difficult to use a BOSA structure realized with focusing beam optics. In order to reduce the excess loss caused due to the center wavelengths for downstream transmission, the BOSA structure realized with collimated beam optics may be used.

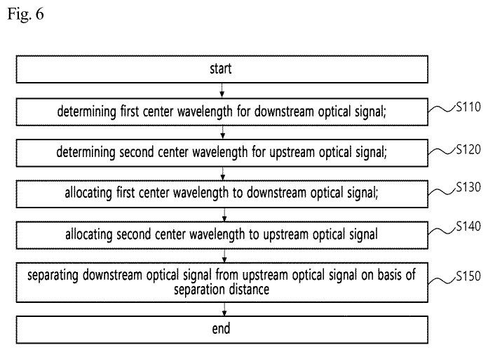

FIG. 6 is a flowchart illustrating the operation of an optical transceiver according to an embodiment of the present disclosure.

In step S110, the optical transceiver determines a first center wavelength for a downstream optical signal.

Herein, the optical transceiver may operate with the operating range of up to 40 km.

In step S120, the optical transceiver determines a second center wavelength for an upstream optical signal.

Herein, the upstream optical signal and the downstream optical signal may be transmitted through a single-mode optical fiber.

In addition, the optical transceiver may identify a signal transmission penalty caused by chromatic dispersion in the optical fiber, and may determine the first center wavelength or the second center wavelength on the basis of the transfer penalty. In addition, the optical transceiver may determine the first center wavelength or the second center wavelength on the basis of a modulation method of the downstream optical signal or the upstream optical signal.

In step S130, the optical transceiver may allocate the first center wavelength to the downstream optical signal.

In step S140, the optical transceiver may allocate the second center wavelength to the upstream optical signal.

Herein, the first center wavelength and the second center wavelength may have a separation distance corresponding to a predetermined wavelength spacing.

In addition, the first center wavelength may be allocated greater than the second center wavelength.

In step S150, the optical transceiver separates the downstream optical signal from the upstream optical signal on the basis of the separation distance.

An optical line terminal (OLT) may set at least one center wavelength for downstream transmission to an optical network unit (ONU). In addition, the optical line terminal may allocate the center wavelength to a downstream optical signal for downstream transmission. Similarly, the optical network unit may set at least one center wavelength different from the center wavelength allocated to at least one optical signal for downstream transmission by the optical line terminal. The optical network unit may allocate the at least one center wavelength to an upstream optical signal for upstream transmission to the optical line terminal.

Herein, a downstream center wavelength may be separated by a preset interval from an upstream center wavelength allocated to an optical signal transmitted from the optical network unit through upstream transmission. The optical line terminal may provide downstream transmission of the downstream optical signal to which the center wavelength is allocated to the optical network unit through the single-mode optical fiber. Herein, the downstream center wavelength may be allocated greater than the upstream center wavelength.

The optical line terminal may provide optical signals to the optical network unit through at least one downstream transmission at the transfer rate of 50 Gb/s per wavelength. In addition, the optical line terminal may operate with the operating range of up to 40 km, and the downstream center wavelength range may be determined on the basis of the operating range.

In addition, the optical network unit may provide optical signals to the optical line terminal through at least one upstream transmission at the transfer rate of 50 Gb/s per wavelength. In addition, the optical network unit may operate with the operating range of up to 40 km, and the upstream center wavelength range may be determined on the basis of the operating range.

For example, when the optical line terminal operates with the transfer rate of 100 Gb/s and the operating range of up to 40 km using optical signals of two wavelengths operating at the transfer rate of 50 Gb/s per wavelength, the center wavelengths for downstream transmission may be set within a range greater than 1300 nm. In addition, when the optical network unit operates with the transfer rate of 100 Gb/s and the operating range of up to 40 km, the upstream center wavelengths for upstream transmission may be set within a lower range than the downstream center wavelengths. Since the optical line terminal and the optical network unit transmit and receive optical signals to and from each other using the optical transceivers, the wavelengths of the optical signals described above and the wavelengths of the optical signals of the optical transceivers have the same operating range.

While the present specification contains a number of specific implementation details, it should be understood that they are not to be construed as limitations on the scope of any disclosure or claims, but as a description of features that may be specific to a particular embodiment of a particular disclosure. Certain features described with respect to contexts of independent embodiments may be implemented in combination in a single embodiment. Conversely, various features described in the context of a single embodiment may also be implemented in other embodiments either individually or in any suitable sub-combination. Further, although some features may be described to operate in a particular combination and may be initially depicted as so claimed, one or more features from the claimed combination may in some cases be excluded from the combination, and a claimed combination may be replaced by a sub-combination or a variant of the sub-combination.

In the meantime, the embodiments of the present disclosure disclosed herein and the drawings are merely provided as specific examples to aid understanding, and are not intended to limit the scope of the present disclosure. It will be apparent to those skilled in the art that in addition to the embodiments disclosed herein, other modifications based on the technical idea of the present disclosure can be implemented.

What is claimed is:

1. An operation method of an optical transceiver, the operation method comprising:
determining a first center wavelength for a downstream optical signal;
determining a second center wavelength for an upstream optical signal;
allocating the first center wavelength to a downstream optical signal;
allocating the second center wavelength to an upstream optical signal, the first center wavelength and the second center wavelength having a separation distance corresponding to a predetermined wavelength spacing therebetween; and
separating the downstream optical signal and the upstream optical signal on the basis of the separation distance.

2. The operation method of claim 1, wherein the first center wavelength is allocated greater than the second center wavelength.

3. The operation method of claim 1, wherein the upstream optical signal and the downstream optical signal are transmitted through a single-mode optical fiber.

4. The operation method of claim 1, wherein the optical transceiver is configured to operate with an operating range of up to 40 km.

5. The operation method of claim 1, wherein the determining of the first center wavelength for the downstream optical signal or the determining of the second center wavelength for the upstream optical signal comprises:
identifying a signal transmission penalty caused by chromatic dispersion in an optical fiber, and
determining the first center wavelength or the second center wavelength on the basis of the transfer penalty.

6. The operation method of claim 5, wherein the determining of the first center wavelength for the downstream optical signal or the determining of the second center wavelength for the upstream optical signal comprises:
determining the first center wavelength or the second center wavelength on the basis of a modulation method of the downstream optical signal or the upstream optical signal.

7. An apparatus for an optical transceiver, the apparatus comprising:
the transceiver; and
at least one controller operably connected to the transceiver,
wherein the at least one controller is configured to perform
determining a first center wavelength for a downstream optical signal;
determining a second center wavelength for an upstream optical signal;
allocating the first center wavelength to a downstream optical signal;
allocating the second center wavelength to an upstream optical signal, the first center wavelength and the second center wavelength having a separation distance corresponding to a predetermined wavelength spacing therebetween; and
separating the downstream and upstream optical signal from the upstream optical signal on the basis of the separation distance.

8. The apparatus of claim 7, wherein the first center wavelength is allocated greater than the second center wavelength.

9. The apparatus of claim 7, wherein the upstream optical signal and the downstream optical signal are transmitted through a single-mode optical fiber.

10. The apparatus of claim 7, wherein the optical transceiver is configured to operate with an operating range of up to 40 km.

11. The apparatus of claim 7, wherein the at least one controller is configured to further perform, in the determining of the first center wavelength for the downstream optical signal or the determining of the second center wavelength for the upstream optical signal,
identifying a signal transmission penalty caused by chromatic dispersion in an optical fiber; and
determining the first center wavelength or the second center wavelength on the basis of the transfer penalty.

12. The apparatus of claim 11, wherein the at least one controller is configured to further perform, in the determining of the first center wavelength for the downstream optical signal or the determining of the second center wavelength for the upstream optical signal,
determining the first center wavelength or the second center wavelength on the basis of a modulation method of the downstream optical signal or the upstream optical signal.
